(19) United States
(12) Patent Application Publication
(10) Pub. No.: US 2026/0260287 A1
(43) Pub. Date: Sep. 3, 2026

(54) USING MACHINE-LEARNING MODELS TO GENERATE BIDDING KEYWORDS FOR SEARCH ENGINES IN ONLINE SYSTEMS

(71) Applicant: Maplebear Inc., San Francisco, CA (US)

(72) Inventors: Vinesh Reddy Gudla, South San Francisco, CA (US); Tejaswi Tenneti, San Carlos, CA (US)

(21) Appl. No.: 19/068,886

(22) Filed: Mar. 3, 2025

(51) Int. Cl. G06Q 30/08; G06Q 30/0201; G06Q 30/0601

(52) U.S. Cl. CPC G06Q 30/08; G06Q 30/0201; G06Q 30/0631

(57) ABSTRACT

An online system includes an interface which facilitates communication between customers and pickers who are servicing the user's order. The customer may request a modification to their order through the interface. The online system performs an inference task in conjunction with the model serving system or the interface system to continuously monitor conversations between users and pickers to infer whether a customer requested to modify their order to maintain an updated order and an updated in-store transaction estimate for the order. The online system determines if the order has been updated to account for the requested changes. If the order has not been updated, the online system automatically updates the customer's order and computes an updated in-store transaction estimate based on the changes made.

### BACKGROUND

An online system is an online platform that connects users and retailers. The online system may maintain a database including one or more orders placed by users. Specifically, a user can place an order for purchasing items, such as groceries, from participating retailers via the online system, with the shopping being done by a personal shopper. After the personal shopper finishes shopping, the order is delivered to the user's address. In search engine marketing (SEM), a retailer may bid on bidding keywords that match search queries submitted by users. Typically, advertising through bidding keywords rely on conversion rates of the keywords. However, this approach has its limitations in that the actual conversion rate in the real-world depends on other factors as well.

### SUMMARY

In accordance with one or more aspects of the disclosure, an online system obtains a set of candidate keywords for a particular geographical region from search queries submitted from user client devices. The online system then accesses a trained machine-learning model to obtain a set of features for a given retailer for each candidate keyword in the set of candidate keywords. The set of features may at least include, distance of the retailer, availability of the related products in the querying region, price distribution of the related products in the querying region, and fill and appeasement rate for the related products in the querying region. To generate likelihoods for converting on one or more products of the retailer in relation to the candidate keyword, the set of parameters of the trained machine learning model is applied to the set of features. The model computes an expected revenue for the candidate keyword, which is dependent on the likelihood. The set of candidate keywords are then ranked in the order of the expected revenue. The online system selects the subset of keywords from the ranked set of candidate keywords. Upon receiving a search query from the particular geographical region that includes a keyword in the subset, the online system performs a bidding process for the keyword in the subset for the retailer. As a response to selecting the retailer for the bidding process, the online system transmits instructions to cause display of a sponsored item for the retailer on the user client device.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example inference process of a machine-learning model with example features for an online system, in accordance with one or more embodiments.

FIG. 3 illustrates an example system architecture for an online system, in accordance with one or more embodiments.

FIG. 4 illustrates an example system architecture for keyword prediction, in accordance with one or more embodiments.

FIG. 5 illustrates an example of a training process of a machine-learning model for keyword prediction, in accordance with one or more embodiments.

FIG. 6 is a flowchart for a method for keyword bidding process, in accordance with one or more embodiments.

### DETAILED DESCRIPTION

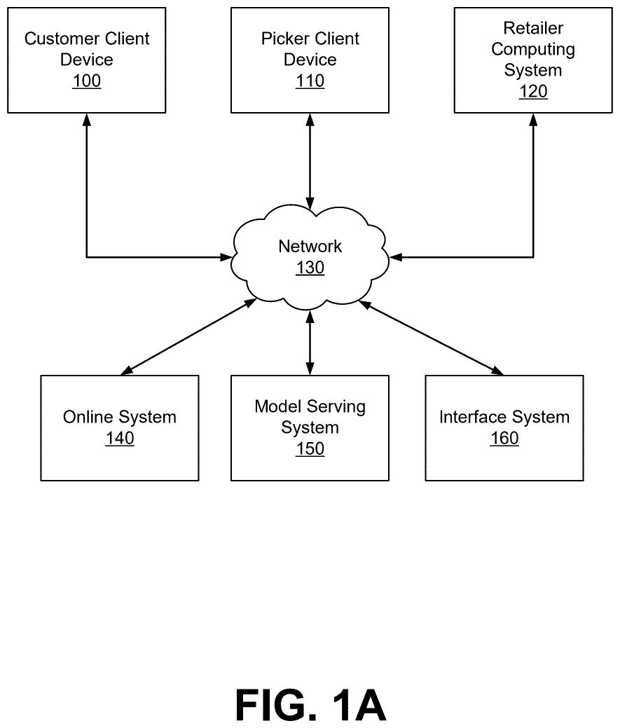

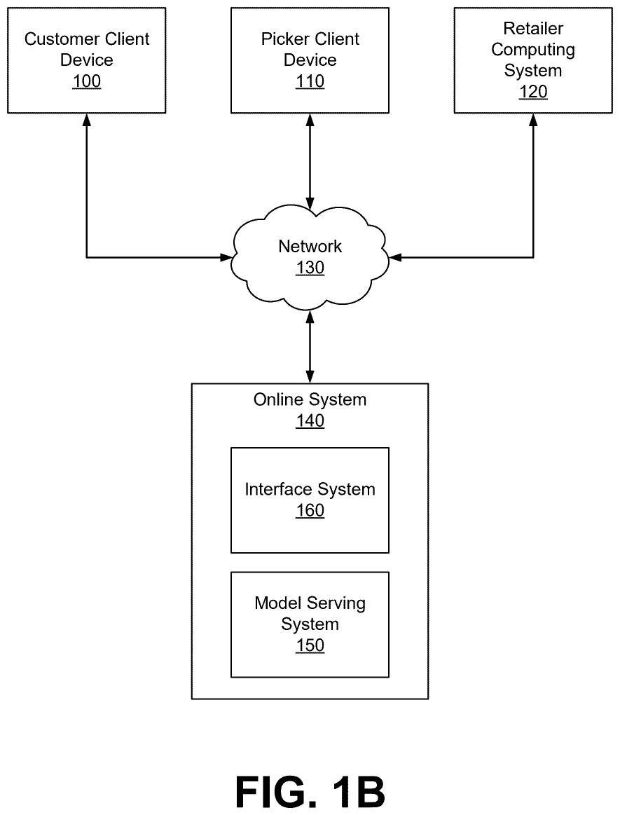

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1A, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the item catalog of the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In one or more embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” may be an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, and/or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, the online system 140, and the model serving system 150 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker user to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

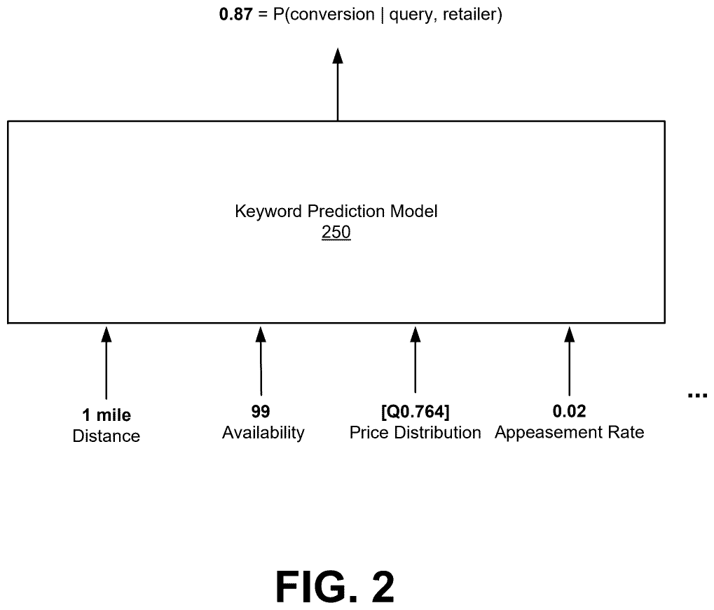

As an example, the online system 140 may allow a customer or user to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker user has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using large-scale machine-learning models. The inference tasks include, but are not limited to, natural language processing (NLP) tasks, audio processing tasks, image processing tasks, video processing tasks, and the like. In one or more embodiments, the machine-learning models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to red-green-blue (RGB) channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learning model of the model serving system 150. Therefore, one type of inference task may be to perform various types of queries on large amounts of data in an external corpus in conjunction with the machine-learning model of the model serving system 150. As an example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learning language model or heuristics. The interface system 160 receives the task requests from the online system 140 based on the external data. The interface system 160 constructs one or more prompts for input to the model serving system 150. A prompt may include the task request of the user and context obtained from the structured index of the external data. In one or more instances, the context in the prompt includes portions of the structured indices as contextual information for the query. The interface system 160 obtains one or more responses to the query from the model serving system 150 and synthesizes a response. While the online system 140 can generate a prompt using the external data as contextual information, often times, the amount of information in the external data exceeds prompt size limitations configured by the machine-learning language model. The interface system 160 can resolve prompt size limitations by generating a structured index of the data and offers data connectors to external data and provides a flexible connector to the external corpus.

In one or more embodiments, the online system 140 trains a machine-learning model to output likelihood of whether a retailer should bid on one or more keywords. Specifically, the online system 140 typically receives a search query from a user of a client device 100. The search query and therefore the user is associated with a particular geographical location. The online system 140 extracts one or more keywords from the search query, and then different retailers can bid on these keywords. If the retailer wins the bid, the retailer can provide sponsored items to the user or advertise items to the user that are associated with the search query.

To determine whether to bid on a certain keyword, some systems use conversion metrics based on, for example, Gross Marketing Value (GMV). However, in the context of an e-commerce platform, customers or users make decisions by considering other factors that are not directly related to revenue, such as distance to retailer, availability of items related to the search query, price of items related to the search query, and the like.

Thus, in one or more embodiments, the online system 140 described herein trains a keyword prediction model that predicts whether a retailer should bid on the keyword based on additional features that incorporate context outside of pure conversion metrics.

Specifically, the online system 140 obtains a set of candidate keywords for a particular geographical region. In one or more embodiments, the candidate keywords are selected by identifying keywords that resulted in a conversion rate above a threshold value or proportion in the geographical region. For example, the set of candidate keywords may be on the order of thousands, tens of thousands, or hundreds of thousands of keywords.

The online system 140 then proceeds to access a trained machine-learning keyword prediction model. This keyword prediction model is associated with a set of trained parameters that have been derived through a prior training process, as further described in detail below.

For a given retailer for a given querying geographical location, and for each candidate keyword in the set of candidate keywords, the online system 140 obtains a set of features that provides additional context for evaluating whether each candidate keyword should be bid on by the retailer. These set of features may include, but are not limited to, distance metrics such as distance to the retailer store from the geographical location (or estimated time of arrival (ETA) if the user ordered from the location), product availability for items related to the candidate keyword in the querying region, price distribution of items related to the candidate keyword in the querying region, and fill and appeasement rates of products at the retailer store in the querying region. In one or more embodiments, when the query is submitted from a particular zip code (e.g., 12345) but there are no retailer locations within that zipcode, the online system 140 may identify a retailer location at the nearest zipcode or other appropriate zipcodes to obtain the features, such as product availability.

FIG. 2 illustrates an example of a model with four types of features for an online system 140, in accordance with one or more embodiments, the set of features may include additional features. The example provides a process of generating predictions for a keyword based on a trained machine-learning keyword prediction model. In FIG. 2, the online system 140 obtains four types of features for an example candidate keyword “oatmeal,” for a geographical location encompassing zip code 12345 for a given retailer ABC Co. Although FIG. 2 illustrates four types of features, in other embodiments, the set of features may include features in addition to those shown in FIG. 2.

For example, one of the features for the keyword prediction model 250 can be labeled as “1 mile=Distance.” This represents the geographical distance between the retailer and the location associated with the user's search query (e.g., “oatmeal”, “12345”). Another feature, “99=Availability,” indicates the inventory of one or more products relevant to the keyword at the retailer's location. This metric ensures the model accounts for the retailer's capacity to meet user's demand. In one or more embodiments, the availability for a keyword may be determined or predicted using an availability model as described herein. In one or more embodiments, another feature labeled “[Q0.764]=Price Distribution” provides the keyword prediction model 250 with pricing information for the retailer's products tied to the keyword. The “0.02=Appeasement Rate” is another feature reflecting customer's satisfaction for the associated retailer, indicating the retailer's performance to meet user expectations.

The online system 140 applies the set of parameters of the machine-learning keyword prediction model 250 to the set of features to generate a likelihood of converting on one or more products of the retailer that are related to the candidate keyword. In other words, the likelihood may indicate whether the retailer should bid on the keyword.

As shown in FIG. 2, the online system 140 may apply parameters of the trained keyword prediction model 250 to the set of features to generate a likelihood of 0.87 for the candidate keyword of “oatmeal” for this geographical location. Assuming that 0 means no likelihood and 1 means highest likelihood, the example likelihood of 0.87 indicates a relatively high likelihood that retailer ABC Co. should bid on the keyword “oatmeal.”

Returning to FIGS. 1A, 1B and 2, after the likelihoods are computed for each candidate keyword, the online system 140 computes the expected revenue (E(GMV)) for the candidate keyword. In one or more embodiments, the expected revenue is dependent on the likelihood multiplied by Gross Market Value, a total value of products sold over a given period.

The online system 140 ranks the set of candidate keywords by the expected revenue of the set of candidate keywords, then selects a subset of keywords for the retailer from the set of candidate keywords based on the expected revenue of the subset keywords.

Upon receiving a search query from the particular geographical region that includes a keyword in the subset, a bidding process for the keyword in the search in the subset for the retailer is performed. This way, the online system 140 can provide keywords to bid for a given retailer depending on not only related to revenue or conversion metrics, but also on factors outside of these metrics that users consider when selecting items during a search session. This allows the retailer and the online system 140 to focus resources on search queries that will more likely result in desired behavior or actions by the user.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

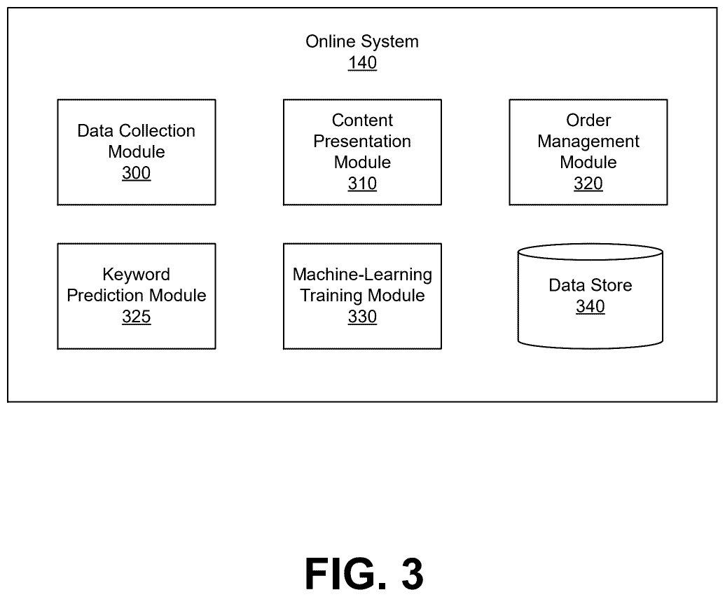

FIG. 3 illustrates an example system architecture for an online system, in accordance with one or more embodiments. The system architecture illustrated in FIG. 3 includes a data collection module 300, a content presentation module 310, an order management module 320, a keyword prediction module 325, a machine learning training module 330, and a data store 340. Alternative embodiments may include more, fewer, or different components from those illustrated in FIG. 3, and the functionality of each component may be divided between the components differently from the description below. Additionally, each component may perform their respective functionalities in response to a request from a human, or automatically without human intervention.

The data collection module 300 collects data used by the online system 140 and stores the data in the data store 340. The data collection module 300 may only collect data describing a user if the user has previously explicitly consented to the online system 140 collecting data describing the user. Additionally, the data collection module 300 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 300 may collect the customer data from sensors on the customer client device 100 or based on the customer's interactions with the online system 140.

The data collection module 300 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 300 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 300 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 300 collects picker data from sensors of the picker client device 110 or from the picker's interactions with the online system 140.

Additionally, the data collection module 300 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 300 also collects communication data, which is different types of communication between shoppers and users of the online system 140. For example, the data collection module 300 may obtain text-based, audio-call, video-call based communications between different shoppers and users of the online system 140 as orders are submitted and fulfilled. The data collection module 300 may store the communication information by individual user, individual shopper, per geographical region, per subset of users having similar attributes, and the like.

The content presentation module 310 selects content for presentation to a customer. For example, the content presentation module 310 selects which items to present to a customer while the customer is placing an order. The content presentation module 310 generates and transmits the ordering interface for the customer to order items. The content presentation module 310 populates the ordering interface with items that the customer may select for adding to their order. In some embodiments, the content presentation module 310 presents a catalog of all items that are available to the customer, which the customer can browse to select items to order. The content presentation module 310 also may identify items that the customer is most likely to order and present those items to the customer. For example, the content presentation module 310 may score items and rank the items based on their scores. The content presentation module 310 displays the items with scores that exceed some threshold (e.g., the top n items or the p percentile of items).

The content presentation module 310 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 340.

In some embodiments, the content presentation module 310 scores items based on a search query received from the customer client device 100. A search query is free text for a word or set of words that indicate items of interest to the customer. The content presentation module 310 scores items based on a relatedness of the items to the search query. For example, the content presentation module 310 may apply natural language processing (NLP) techniques to the text in the search query to generate a search query representation (e.g., an embedding) that represents characteristics of the search query. The content presentation module 310 may use the search query representation to score candidate items for presentation to a customer (e.g., by comparing a search query embedding to an item embedding).

In some embodiments, the content presentation module 310 scores items based on a predicted availability of an item. The content presentation module 310 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 310 may weigh the score for an item based on the predicted availability of the item. Alternatively, the content presentation module 310 may filter out items from presentation to a customer based on whether the predicted availability of the item exceeds a threshold.

In one or more embodiments, the content presentation module 310 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 310 may present the equivalent basket to the customer via the ordering interface with an indicator that states how an equivalent basket improves or is different from the existing basket (e.g., more cost-effective, healthier, sponsored by a certain organization). The content presentation module 310 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 310 may present each suggested recipe and the list of additional ingredients for fulfilling the recipe to the customer. The content presentation module 310 may allow the customer to automatically place one or more additional ingredients in the basket of the customer.

The order management module 320 that manages orders for items from users. The order management module 320 receives orders from a customer client device 100 and offers the orders to pickers for service based on picker data. For example, the order management module 320 offers an order to a picker based on the picker's location and the location of the retailer from which the ordered items are to be collected. The order management module 320 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 320 determines when to offer an order to a picker based on a delivery timeframe requested by the customer with the order. The order management module 320 computes an estimated amount of time that it would take for a picker to collect the items for an order and deliver the ordered item to the delivery location for the order. The order management module 320 offers the order to a picker at a time such that, if the picker immediately services the order, the picker is likely to deliver the order at a time within the timeframe. Thus, when the order management module 320 receives an order, the order management module 320 may delay in offering the order to a picker if the timeframe is far enough in the future.

When the order management module 320 offers an order to a picker, the order management module 320 transmits the order to the picker client device 110 associated with the picker. The order management module 320 may also transmit navigation instructions from the picker's current location to the retailer location associated with the order. If the order includes items to collect from multiple retailer locations, the order management module 320 identifies the retailer locations to the picker and may also specify a sequence in which the picker should visit the retailer locations.

The order management module 320 may track the location of the picker through the picker client device 110 to determine when the picker arrives at the retailer location. When the picker arrives at the retailer location, the order management module 320 transmits the order to the picker client device 110 for display to the picker. As the picker uses the picker client device 110 to collect items at the retailer location, the order management module 320 receives item identifiers for items that the picker has collected for the order. In some embodiments, the order management module 320 receives images of items from the picker client device 110 and applies computer-vision techniques to the images to identify the items depicted by the images. The order management module 320 may track the progress of the picker as the picker collects items for an order and may transmit progress updates to the customer client device 100 that describe which items have been collected for the customer's order.

In some embodiments, the order management module 320 tracks the location of the picker within the retailer location. The order management module 320 uses sensor data from the picker client device 110 or from sensors in the retailer location to determine the location of the picker in the retailer location. The order management module 320 may transmit to the picker client device 110 instructions to display a map of the retailer location indicating where in the retailer location the picker is located. Additionally, the order management module 320 may instruct the picker client device 110 to display the locations of items for the picker to collect, and may further display navigation instructions for how the picker can travel from their current location to the location of a next item to collect for an order.

The order management module 320 determines when the picker has collected all of the items for an order. For example, the order management module 320 may receive a message from the picker client device 110 indicating that all of the items for an order have been collected. Alternatively, the order management module 320 may receive item identifiers for items collected by the picker and determine when all of the items in an order have been collected. When the order management module 320 determines that the picker has completed an order, the order management module 320 transmits the delivery location for the order to the picker client device 110. The order management module 320 may also transmit navigation instructions to the picker client device 110 that specify how to travel from the retailer location to the delivery location, or to a subsequent retailer location for further item collection. The order management module 320 tracks the location of the picker as the picker travels to the delivery location for an order, and updates the customer with the location of the picker so that the customer can track the progress of their order. In some embodiments, the order management module 320 computes an estimated time of arrival for the picker at the delivery location and provides the estimated time of arrival to the customer.

In some embodiments, the order management module 320 facilitates communication between the customer client device 100 and the picker client device 110. As noted above, a customer may use a customer client device 100 to send a message to the picker client device 110. The order management module 320 receives the message from the customer client device 100 and transmits the message to the picker client device 110 for display to the picker. The picker may use the picker client device 110 to send a message to the customer client device 100 in a similar manner.

The order management module 320 coordinates payment by the customer for the order. The order management module 320 uses payment information provided by the customer (e.g., a credit card number or a bank account) to receive payment for the order. In some embodiments, the order management module 320 stores the payment information for use in subsequent orders by the customer. The order management module 320 computes a total cost for the order and charges the customer that cost. The order management module 320 may provide a portion of the total cost to the picker for servicing the order, and another portion of the total cost to the retailer.

In one or more embodiments, the keyword prediction module 325 is a module for training the keyword prediction model and applying the keyword prediction model to candidate keywords to determine whether a retailer should bid on a keyword in an associated geographical region.

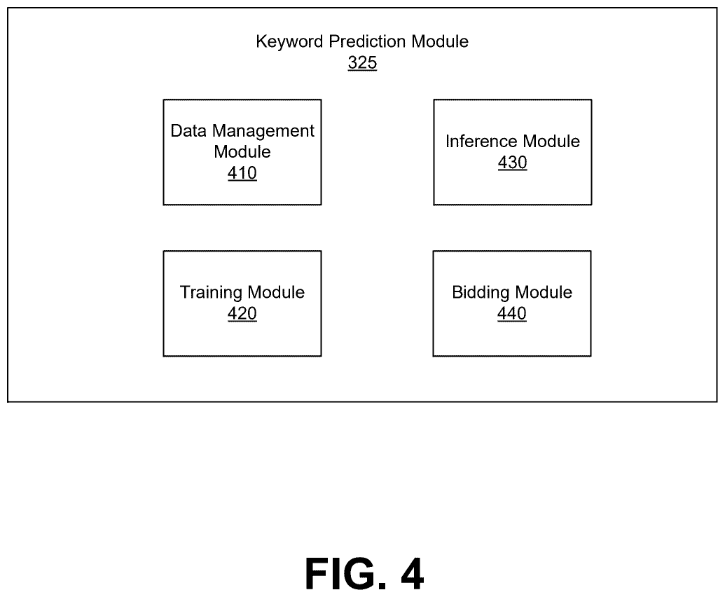

FIG. 4 illustrates an example system architecture for the keyword prediction module 325, in accordance with one or more embodiments. In one or more embodiments, the keyword prediction module 325 may include data management module 410, training module 420, inference module 430, and bidding module 440.

The data management module 410 manages training data, which includes a set of training examples. In one or more embodiments, each training example includes a set of features associated with a keyword, identified from a previous search query originating from a specific geographical region (e.g., zip code of interest). As described above in conjunction with FIG. 2, the set of features for a training example may include the geographical distance between the retailer and the location associated with the previous search query, inventory of one or more products relevant to the previous search query at the retailer's location, pricing information for the retailer's products related to the keyword, and appeasements reflecting customers' satisfaction for the retailer. Additionally, each training example includes a label indicating whether a conversion occurred for the search query associated with a particular retailer. In one or more embodiments, the label is 0 if no conversion occurred and 1 if a conversion occurred for the search query (e.g., user purchased at least 1 item that was presented as a result to the search query). The set of training examples is then divided into one or more batches for efficient processing during iterative training.

The training module 420 trains parameters of the keyword prediction model using batches of training examples over one or more iterations to train the parameters. For each iteration, the parameters of the keyword prediction model are applied to the set of features in the respective batch of training examples for a current iteration to generate estimated outputs. The outputs indicate predictions, the likelihood of conversion for the corresponding search query. The training module 420 then computes a loss function by comparing the estimated outputs with actual conversion rate of the respective batch of training examples. The loss function calculates the difference between the estimated outputs and the ground truth. Using backpropagation, the keyword prediction model propagates one or more terms from the loss function to update the set of parameters of the keyword prediction model. This recursive iteration of the training process refines the parameters of the model.

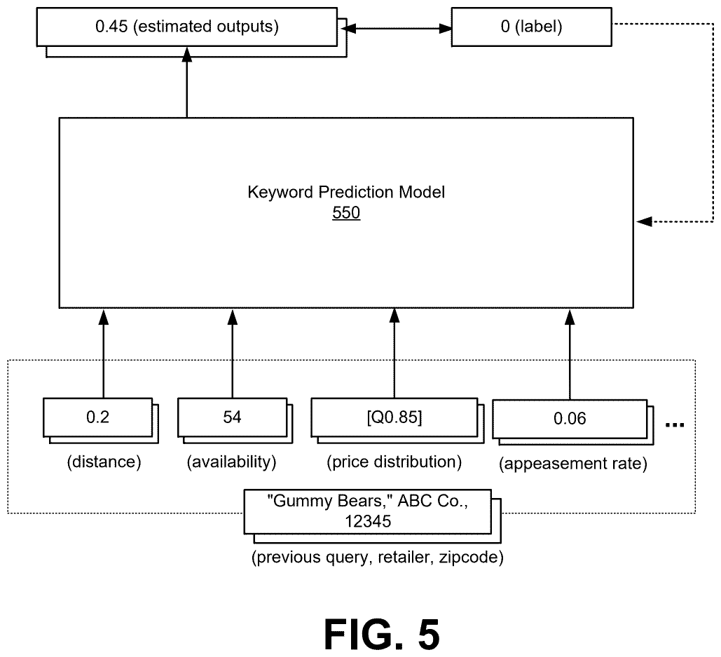

FIG. 5 illustrates an example of a training process of a machine learning model for keyword prediction, in accordance with one or more embodiments. The keyword prediction model 550 is coupled to receive the set of features associated with a keyword (or search query) and generate a predicted likelihood. The training process starts with the input of relevant features into the keyword prediction model 550 obtained from the batch of training examples for the iteration shown in FIG. 5. Once one or more input features are provided, the keyword prediction model 550 processes the data using its pretrained parameters to generate estimated outputs for the batch, the estimated likelihood of conversion for a search query. For example, as shown in the figure, the model predicts an estimated output of “0.45” during the forward pass step for a given training example, indicating the likelihood of conversion for that search query.

Assuming training a keyword “gummy bears” which is associated with retailer “ABC Co.” in a particular geographical region characterized by example postal code “12345”, the input of training data includes a set of relevant features from keyword “gummy bears.” For example, in FIG. 5, a set of features including distance, availability, price distribution, and appeasement rate are extracted for the first training example. The “0.2” is the geographical distance between the retailer “ABC Co.” and the location associated with the user's search query. The “54” is an inventory of one or more products relevant to the keyword “gummy bears” at “ABC Co.” associated with postal code “12345.” Another feature labeled “[Q0.85]” is quantile referring to the price distribution of “gummy bears.” The “0.06” is appeasement rate, which indicates the retailer's performance to meet user expectations. Further, the label for the same training example indicates “0,” meaning that the user who submitted the query of “gummy bear” did not convert.

The estimated output is then compared with ground truth, which, in one or more embodiments, may indicate the occurrence of a conversion labeled as a binary value. The discrepancy between the estimated output and the actual value is calculated using a loss function. The training module 420 then uses backpropagation to update the parameters of the keyword prediction model 325.

In one or more embodiments, the training module 420 obtains feedback in conjunction with the bidding module 440, regarding whether the user made a conversion for the sponsored item in response to the user's search query. The training module 420 generates an additional training example based on the values for the set of features and the obtained feedback. Further, the training module 420 retrains parameters of the machine-learning model using the generated additional training example.

As described in conjunction with FIGS. 1A, 1B and 2, the inference module 430 may select a set of candidate keywords, obtain likelihoods for a given retailer for a given geographical region, and select a subset of keywords for the retailer to bid on for the region. The inference module 430 applies the trained keyword prediction model to a set of features obtained for each candidate keyword to generate a likelihood for the candidate keyword. The inference module 430 selects a subset of keywords for the retailer to bid on based on the generated likelihoods. For example, the inference module 430 may select the candidate keywords with the highest 100 likelihoods.

Also, as described above, in one or more embodiments, the candidate keywords are ranked according to the expected revenue (E(GMV)) for the candidate keywords. In one or more embodiments, the expected revenue is dependent on the likelihood multiplied by Gross Market Value, a total value of products sold over a given period multiplied by the generated likelihood from the model. In such an instance, the expected revenue can be written as:
P(conversion|query, retailer)*GMV(query, retailer),
   where P denotes the generated likelihood and GMV is the expected revenue amount for a given query (keyword) for a retailer.

In one or more embodiments, the inference module 430 further incorporates additional objectives in addition or replacing the expected revenue above. In some instances, an additional objective is to include expected advertisement or sponsorship revenue associated with keywords for a retailer. In some instances, another additional objective is to include expected lifetime value (LTV) or retention rates associated with keywords for a retailer. These additional objectives can be combined with the expected revenue approach and weighted depending on which aspect is important. For example, the bid for a keyword may be given by:
w1*E(GMV)+w2*ads_revenue+w3*LTV
   where w1 is the weight for expected revenue, w2 is the weight for expected advertisement revenue of a keyword for a retailer, and w3 is the weight for LTV of a keyword for the retailer.

Specifically, for a given retailer, the inference module 430 identifies a selected subset of keywords to bid on per geographical region by incorporating factors or features that capture granularity with respect to the different geographical regions that may affect the performance of the keyword bid. Therefore, a retailer may bid on different subsets of keywords depending on the location of the search query and the set of factors described herein, different from conventional bidding systems. The inference module 430 performs the process described herein for other sets of retailers as well.

In one or more embodiments, the set of features, such as availability or appeasement or dependability may change over time. For example, an item that was out-of-stock may get re-stocked later during the day or later in the week. The inference module 430 thus may iteratively update the keywords for bidding as values for the features change over time.

The bidding module 440 receives a search query from a user, where the user is associated with a geographical region. The bidding module 440 also maintains a bidding list of selected keywords for each retailer for each geographical region that were identified by the process described above. Responsive to a bidding opportunity with a keyword obtained from the search query, the bidding module 440 receives bids from multiple retailers that have the keyword in their bidding list. Once a search query from a user is matched to a keyword from the bidding list, the retailers associated with the keyword list will bid on that keyword. The retailer who wins, gets to present a sponsored item to the user. In one or more embodiments, the sponsored item includes an advertisement, a sponsored item related to the keyword for the retailer, and the like.

The machine learning training module 330 trains machine learning models used by the online system 140. For example, the machine learning module 330 may train the item selection model, the availability model, or any of the machine-learning models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 330 generates the set of parameters for a machine learning model by “training” the machine learning model. Once trained, the machine learning model uses the set of parameters to transform inputs into outputs.

The machine learning training module 330 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 330 may apply an iterative process to train a machine learning model whereby the machine learning training module 330 trains the machine learning model on each of the set of training examples. To train a machine learning model based on a training example, the machine learning training module 330 applies the machine learning model to the input data in the training example to generate an output. The machine learning training module 330 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 330 updates the set of parameters for the machine learning model based on the score generated by the loss function. For example, the machine learning training module 330 may apply gradient descent to update the set of parameters.

The data store 340 stores data used by the online system 140. For example, the data store 340 stores customer data, item data, order data, and picker data for use by the online system 140. The data store 340 also stores trained machine learning models trained by the machine learning training module 330. For example, the data store 340 may store the set of parameters for a trained machine learning model on one or more non-transitory, computer-readable media. The data store 340 uses computer-readable media to store data, and may use databases to organize the stored data.

With respect to the machine-learning models hosted by the model serving system 150, the machine-learning models may already be trained by a separate entity from the entity responsible for the online system 140. In another embodiment, when the model serving system 150 is included in the online system 140, the machine-learning training module 330 may further train parameters of the machine-learning model based on data specific to the online system 140 stored in the data store 340. As an example, the machine-learning training module 330 may obtain a pre-trained transformer language model and further fine tune the parameters of the transformer model using training data stored in the data store 340. The machine-learning training module 330 may provide the model to the model serving system 150 for deployment.

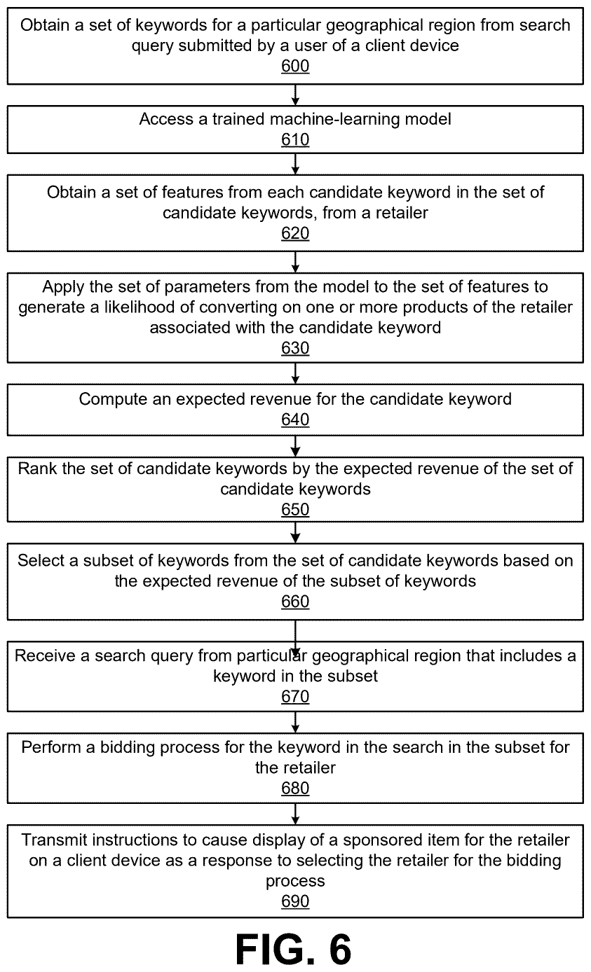

FIG. 6 is a flowchart for a method for keyword bidding process for a particular geographical region, in accordance with one or more embodiments. Alternative embodiments may include more, fewer, or different steps from those illustrated in FIG. 6, and the steps may be performed in a different order from that illustrated in FIG. 6. These steps may be performed by an online system (e.g., online system 140). Additionally, each of these steps may be performed automatically by the online system without human intervention.

The online system obtains 600, a set of keywords for a particular geographical region from a search query submitted by a user of a client service. The online system accesses 610, a trained machine learning model that is associated with a set of trained parameters.

The online system obtains 620, a set of features from each candidate keyword in the set of candidate keywords from a retailer. The online system applies 630, the set of parameters from the model to the set of features to generate a likelihood of converting on one or more products of the retailer associated with the candidate keyword. The online system computes 640, an expected revenue for the candidate keyword.

The online system ranks 650, the set of candidate keywords by the expected revenue of the set of candidate keywords and then selects 660, a subset of keywords from the set of candidate keywords based on the expected revenue of the subset of keywords. The online system receives 670, a search query from a particular geographical region that includes a keyword in the subset. The online system performs 680, a bidding process for the keyword in the search in the subset for the retailer. Responsive to selecting the retailer for the bidding process, the online system transmits 690 instructions to cause display of a sponsored item for the retailer on a client device.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, comprising:
obtaining a set of candidate keywords for a particular geographical region;
accessing a trained machine-learning model, wherein the machine-learning model is associated with a set of trained parameters;
for a retailer and for each candidate keyword in the set of candidate keywords:
obtaining values for a set of features including one or more of: (i) distance of the retailer from the particular geographical region and related products to the candidate keyword, (ii) availability of the related products in the retailer from the particular geographical region, (iii) price distribution of the related products in the particular geographical region, or (iv) fill and appeasement rate for the related products in the particular geographical region,
applying the set of parameters of the machine-learning model to the values for the set of features to generate a likelihood of converting on one or more products of the retailer that are related to the candidate keyword, and
generating an expected revenue for the candidate keyword, wherein the expected revenue is dependent on the likelihood;
ranking the set of candidate keywords by the expected revenue of the set of candidate keywords;
selecting a subset of keywords from the set of candidate keywords based on the expected revenue of the subset of keywords;
receiving a search query from the particular geographical region that includes a keyword in the subset;
performing a bidding process for the keyword to obtain bids from one or more retailers; and
responsive to selecting the retailer from the one or more retailers based on the bidding process, transmitting instructions to cause display of a sponsored item for the retailer on a client device.

2. The method of claim 1, further comprising:
obtaining training data including a set of training examples, a training example including values for the set of features for a training keyword, the training example including a label indicating whether there was a conversion for the search query for the retailer or another retailer.

3. The method of claim 2, wherein the training keyword for the training example is identified from a previous search query submitted by a user from a geographical region.

4. The method of claim 2, further comprising:
dividing the set of training examples into one or more batches for one or more iterations;
for the one or more iterations:
applying the set of parameters of the machine-learning model to the values for the set of features of a respective batch of training examples for a current iteration to generate estimated outputs,
computing a loss function that indicates a difference between the estimated outputs and the labels of the respective batch of training examples; and
backpropagating one or more terms from the loss function to update the set of parameters of the machine-learning model.

5. The method of claim 1, obtaining the set of candidate keywords further comprises:
obtaining candidate keywords and conversation rates associated with the candidate keywords in the particular geographical region; and selecting the set of candidate keywords that have the conversion rates above a threshold value or proportion.

6. The method of claim 1, wherein for each candidate keyword, the expected revenue for the candidate keyword is generated by combining the likelihood for the candidate keyword with a gross market value (GMV), wherein the GMV indicates a total value of related products sold over a period.

7. The method of claim 1, wherein the search query is received from the particular geographical region for the retailer, the subset of keywords to bid for the geographical region is different from a second subset of keywords to bid for a second geographical region.

8. The method of claim 1, further comprising:
obtaining feedback from a user of the client device on whether the user converted on the sponsored item;
generating an additional training example based on the values for the set of features and the obtained feedback; and
retraining parameters of the machine-learning model based on the additional training example.

9. A non-transitory computer readable storage medium storing instruction that, when executed by a computer processor, cause the computer processor to perform operations comprising:
obtaining a set of candidate keywords for a particular geographical region;
accessing a trained machine-learning model, wherein the machine-learning model is associated with a set of trained parameters;
for a retailer and for each candidate keyword in the set of candidate keywords:
obtaining values for a set of features including one or more of (i) distance of the retailer from the particular geographical region and related products to the candidate keyword, (ii) availability of the related products in the retailer from the particular geographical region, (iii) price distribution of the related products in the particular geographical region, or (iv) fill and appeasement rate for the related products in the particular geographical region,
applying the set of parameters of the machine-learning model to the values for the set of features to generate a likelihood of converting on one or more products of the retailer that are related to the candidate keyword, and
generating an expected revenue for the candidate keyword, wherein the expected revenue is dependent on the likelihood;
ranking the set of candidate keywords by the expected revenue of the set of candidate keywords;
selecting a subset of keywords from the set of candidate keywords based on the expected revenue of the subset of keywords;
receiving a search query from the particular geographical region that includes a keyword in the subset;
performing a bidding process for the keyword to obtain bids from one or more retailers; and
responsive to selecting the retailer from the one or more retailers based on the bidding process, transmitting instructions to cause display of a sponsored item for the retailer on a client device.

10. The non-transitory computer readable medium of claim 9, the operations further comprising:
obtaining training data including a set of training examples, a training example including values for the set of features for a training keyword, the training example including a label indicating whether there was a conversion for the search query for the retailer or another retailer.

11. The non-transitory computer readable medium of claim 10, wherein the training keyword for the training example is identified from a previous search query submitted by a user from a geographical region.

12. The non-transitory computer readable medium of claim 10, further comprising:
dividing the set of training examples into one or more batches for one or more iterations;
for the one or more iterations:
applying the set of parameters of the machine-learning model to the values for the set of features of a respective batch of training examples for a current iteration to generate estimated outputs,
computing a loss function that indicates a difference between the estimated outputs and the labels of the respective batch of training examples; and
backpropagating one or more terms from the loss function to update the set of parameters of the machine-learning model.

13. The non-transitory computer readable medium of claim 9, obtaining the set of candidate keywords further comprises:
obtaining candidate keywords and conversation rates associated with the candidate keywords in the particular geographical region; and
selecting the set of candidate keywords that have the conversion rates above a threshold value or proportion.

14. The non-transitory computer readable medium of claim 9, wherein for each candidate keyword, the expected revenue for the candidate keyword is generated by combining the likelihood for the candidate keyword with a gross market value (GMV), wherein the GMV indicates a total value of related products sold over a period.

15. The non-transitory computer readable medium of claim 9, wherein the search query is received from the particular geographical region for the retailer, the subset of keywords to bid for the geographical region is different from a second subset of keywords to bid for a second geographical region.

16. The non-transitory computer readable medium of claim 9, further comprising:
obtaining feedback from a user of the client device on whether the user converted on the sponsored item;
generating an additional training example based on the values for the set of features and the obtained feedback; and
retraining parameters of the machine-learning model based on the additional training example.

17. A computer system comprising: a computer processor; and
a non-transitory computer-readable storage medium storing instructions that, when executed by the computer processor, cause the computer processor to perform operations comprising:
obtaining a set of candidate keywords for a particular geographical region;
accessing a trained machine-learning model, wherein the machine-learning model is associated with a set of trained parameters;
for a retailer and for each candidate keyword in the set of candidate keywords:
obtaining values for a set of features including one or more of (i) distance of the retailer from the particular geographical region and related products to the candidate keyword, (ii) availability of the related products in the retailer from the particular geographical region, (iii) price distribution of the related products in the particular geographical region, or (iv) fill and appeasement rate for the related products in the particular geographical region,
applying the set of parameters of the machine-learning model to the values for the set of features to generate a likelihood of converting on one or more products of the retailer that are related to the candidate keyword, and
generating an expected revenue for the candidate keyword, wherein the expected revenue is dependent on the likelihood;
ranking the set of candidate keywords by the expected revenue of the set of candidate keywords;
selecting a subset of keywords from the set of candidate keywords based on the expected revenue of the subset of keywords;
receiving a search query from the particular geographical region that includes a keyword in the subset;
performing a bidding process for the keyword to obtain bids from one or more retailers; and
responsive to selecting the retailer from the one or more retailers based on the bidding process, transmitting instructions to cause display of a sponsored item for the retailer on a client device.

18. The computer system of claim 17, the operations further comprising:
obtaining training data including a set of training examples, a training example including values for the set of features for a training keyword, the training example including a label indicating whether there was a conversion for the search query for the retailer or another retailer.

19. The computer system of claim 17, the operations further comprising:
obtaining candidate keywords and conversation rates associated with the candidate keywords in the particular geographical region; and selecting the set of candidate keywords that have the conversion rates above a threshold value or proportion.

20. The computer system of claim 17, the operations further comprising:
obtaining feedback from a user of the client device on whether the user converted on the sponsored item;
generating an additional training example based on the values for the set of features and the obtained feedback; and
retraining parameters of the machine-learning model based on the additional training example.
